(19) United States
(12) Patent Application Publication
(10) Pub. No.: US 2005/0047509 A1
(43) Pub. Date: Mar. 3, 2005

(54) Scalable video coding and decoding methods, and scalable video encoder and decoder

(75) Inventors: Bae-keun Lee, Bucheon-si (KR); Ho-jin Ha, Seoul (KR); Woo-jin Han, Suwon-si (KR); Jae-young Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/925,013

(22) Filed: Aug. 25, 2004

Related U.S. Application Data
(60) Provisional application No. 60/497,566, filed on Aug. 26, 2003.

(30) Foreign Application Priority Data
Sep. 26, 2003 (KR) 2003-0066958
Jan. 12, 2004 (KR) 2004-0002013

(51) Int. Cl. H04N 7/12

(52) U.S. Cl. 375/240.19; 375/240.12; 375/240.03; 375/240.18; 375/240.11

(57) ABSTRACT

Scalable video coding and decoding methods, a scalable video encoder, and a scalable video decoder. The scalable video coding method includes receiving a GOP, performing temporal filtering and spatial transformation thereon, quantizing and generating a bitstream. The scalable video encoder for performing the scalable video coding method includes a weight determination block which determines a weight for scaling. The scalable video decoding method includes dequantizing the coded image information obtained from a received bitstream, performing descaling, inverse spatial transformation, and inverse temporal filtering on the scaled transform coefficients, thereby recovering video frames. The scalable video decoder for performing the scalable video decoding method includes an inverse weighting block. The standard deviation of Peak Signal to Noise Ratios (PSNRs) of frames included in a group of pictures (GOP) is reduced so that video coding performance can be increased.

### CROSS-REFERENCE TO RELATED APPLICATIONS

This application claims priority from Korean Patent Application Nos. 10-2003-0066958 and 10-2004-0002013 filed on Sep. 26, 2003 and Jan. 12, 2004, respectively, with the Korean Intellectual Property Office, and U.S. Provisional Patent Application No. 60/497,566 filed on Aug. 26, 2003 with the United States Patent and Trademark Office, the disclosures of which are incorporated herein in their entireties by reference.

### BACKGROUND OF THE INVENTION

1. Field of the Invention

The present invention relates to video compression, and more particularly, to scalable video coding and decoding methods using a weight, and an encoder and a decoder using the methods, respectively.

2. Description of the Related Art

With the development of information communication technology including the Internet, video communication as well as text and voice communication has increased.

Conventional text communication cannot satisfy the various demands of users, and thus demand for multimedia services that can provide various types of information such as text, pictures, and music have increased. Multimedia data requires a large capacity storage medium and a wide bandwidth for transmission since the amount of multimedia data is usually large. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency signals. Data compression can be classified into lossy/lossless compression according to whether source data is lost, intraframe/interframe compression according to whether individual frames are compressed independently, and symmetric/asymmetric compression according to whether time required for compression is the same as time required for recovery. Data compression is defined as real-time compression when a compression/recovery time delay does not exceed 50 ms and as scalable compression when frames have different resolutions. For text or medical data, lossless compression is usually used. For multimedia data, lossy compression is usually used. Meanwhile, intraframe compression is usually used to remove spatial redundancy, and interframe compression is usually used to remove temporal redundancy.

Different types of transmission media for multimedia have different performance. Currently used transmission media have various transmission rates. For example, an ultrahigh-speed communication network can transmit data of several tens of megabits per second while a mobile communication network has a transmission rate of 384 kilobits per second. In conventional video coding methods such as Motion Picture Experts Group (MPEG)-1, MPEG-2, H.263, and H.264, temporal redundancy is removed by motion compensation based on motion estimation and compensation, and spatial redundancy is removed by transform coding. These methods have satisfactory compression rates, but they do not have the flexibility of a truly scalable bitstream since they use a reflexive approach in a main algorithm. Accordingly, to support transmission media having various speeds or to transmit multimedia at a data rate suitable to a transmission environment, data coding methods having scalability, such as wavelet video coding and subband video coding, may be suitable to a multimedia environment. Scalability indicates the ability to partially decode a single compressed bitstream. Scalability includes spatial scalability indicating a video resolution, Signal to Noise Ratio (SNR) scalability indicating a video quality level, and temporal scalability indicating a frame rate. A scalable video encoder codes a single stream and can transmit part of the coded stream at different quality levels, resolutions, or frame rates to adapt to limiting conditions such as bit rate, errors, and resources. A scalable video decoder can decode a transmitted video stream while changing quality level, resolution, or frame rate.

Interframe Wavelet Video Coding (IWVC) can provide a very flexible, scalable bitstream. However, conventional IWVC has lower performance than a coding method such as H.264. Due to this lower performance, IWVC is used only for very limited applications although it has very excellent scalability. Accordingly, it has been an issue to improve the performance of data coding methods having scalability.

FIG. 1 is a flowchart of IWVC.

An image is received in units of a group of pictures (GOP) including a plurality of frames in step S1. Preferably, the GOP includes 2ⁿ (n=1, 2, 3, . . . ) frames for temporal scalability. In an embodiment of the present invention, the GOP includes 16 frames, and various operations are performed in GOP units.

Next, motion estimation is performed using Hierarchical Variable Size Block Matching (HVSBM) in step S2. When an original image size is N*N, images of level 0 (N*N), of level 1 (N/2*N/2), and of level 2 (N/4*N/4) are obtained using wavelet transformation. For the level 2 images, a motion estimation block size is changed from 16*16 to 8*8 and 4*4, motion estimation is performed on each block, and a Magnitude of Absolute Distortion (MAD) is obtained with respect to each block. Similarly, for the level 1 images, the motion estimation block size is changed from 32*32 to 16*16, 8*8, and 4*4, motion estimation is performed on each block, and a MAD is obtained with respect to each block. For the level 0 images, the motion estimation block size is changed from 64*64 to 32*32, 16*16, 8*8, and 4*4, motion estimation is performed on each block, and a MAD is obtained with respect to each block.

Next, a motion estimation tree is pruned to minimize the MAD in step S3.

Then, Motion Compensated Temporal Filtering (MCTF) is performed using the pruned optimal motion estimation tree in step S4, which will be described with reference to FIG. 2. Referring to FIG. 2, the number written within each frame denotes the frame's position in a temporal sequence, and Wn (where n=1, 2, . . . 15) indicates a subband obtained after MCTF. In other words, fr0 through fr15 indicate 16 frames included in a single GOP before they are subjected to MCTF.

First, in temporal level 0, MCTF is performed forward with respect to 16 image frames, thereby obtaining 8 low-frequency frames and 8 high-frequency subbands W8, W9, W10, W11, W12, W13, W14, and W15. In temporal level 1, MCTF is performed forward with respect to the 8 low-frequency frames, thereby obtaining 4 low-frequency frames and 4 high-frequency subbands W4, W5, W6, and W7. In temporal level 2, MCTF is performed forward with respect to the 4 low-frequency frames obtained in temporal level 1, thereby obtaining 2 low-frequency frames and 2 high-frequency subbands W2 and W3. Lastly, in temporal level 3, MCTF is performed forward with respect to the 2 low-frequency frames obtained in temporal level 2, thereby obtaining a single low-frequency subband W0 and a single high-frequency subband W1. Accordingly, as a result of MCTF, a total of 16 subbands W0 through W15 including 15 high-frequency subbands and a single low-frequency subband at the last level are obtained. After obtaining the 16 subbands, spatial transformation and quantization are performed on the 16 subbands in step S5 of FIG. 1. Thereafter, a bitstream including data resulting from the spatial transformation and the quantization and motion vector data resulting from the motion estimation are generated in step S6.

Although conventional IWVC has excellent scalability, it still has disadvantages. Generally, to quantitatively measure the performance of video coding, a Peak Signal to Noise Ratio (PSNR) is used. When the difference between an original image and a coded image is small, a PSNR value is large. When a difference between an original image and a coded image is large, a PSNR value is small. A PSNR value is infinite when two images are exactly the same. FIG. 3 shows a distribution of average PSNR values with respect to frame indexes in conventional IWVC. As shown in FIG. 3, PSNR values vary greatly with respect to frame indexes within a GOP. PSNR values become smaller at positions such as fr0, fr4, fr8, fr12, and fr16 (i.e., fr0 in another GOP) than at their neighboring positions. When PSNR values vary greatly with respect to frame indexes, video picture quality varies greatly over time. When picture quality varies greatly temporarily, people perceive that picture quality is degraded. As described above, differences in picture quality impede commercial services such as streaming services. Accordingly, decreasing an amount of variation in a PSNR value is essential to wavelet-based scalable video coding. Meanwhile, decreasing an amount of variation in a PSNR value between frames within a GOP is important in scalable video coding using wavelet-based spatial transformation and is also important in scalable video coding using other types of spatial transformation such as discrete cosine transformation (DCT).

### SUMMARY OF THE INVENTION

The present invention provides scalable video coding and decoding methods allowing changes in Peak Signal to Noise Ratio (PSNR) to be decreased, and a scalable video encoder and decoder therefor.

According to an aspect of the present invention, there is provided a scalable video coding method comprising (a) receiving a plurality of video frames and performing Motion Compensated Temporal Filtering (MCTF) on the plurality of video frames to remove temporal redundancy from the video frames; and (b) obtaining scaled transform coefficients from the video frames from which the temporal redundancy is removed, quantizing the scaled transform coefficients, and generating a bitstream.

The video frames received in step (a) above have been subjected to wavelet transformation so that spatial redundancy has been removed from the video frames, and the scaled transform coefficients may be obtained by applying a predetermined weight to some subbands among the video frames from which the temporal redundancy has been removed.

The scaled transform coefficients may also be obtained in step (b) by applying a predetermined weight to some subbands among the video frames from which the temporal redundancy has been removed and performing spatial transformation on the weighted subbands.

Preferably, the scaled transform coefficients are obtained in step (b) by performing spatial transformation on the video frames from which the temporal redundancy has been removed and applying a predetermined weight to transform coefficients obtained from some subbands among transform coefficients generated through the spatial transformation. In this case, the predetermined weight is determined for each group of pictures (GOP). The predetermined weight has a single value for a single GOP and is preferably determined on the basis of a magnitude of absolute distortion of the GOP. Here, the transform coefficients scaled using the predetermined weight are preferably obtained from subbands that exert substantially little influence on high Peak Signal to Noise Ratio (PSNR) frames than low PSNR frames among subbands used to construct low PSNR frames.

The bitstream generated in step (b) may comprise information regarding a weight used to obtain the scaled transform coefficients.

According to another aspect of the present invention, there is provided a scalable video encoder which receives a plurality of video frames and generates a bitstream. The scalable video encoder comprises a temporal filtering block which performs MCTF on the video frames to remove temporal redundancy from the video frames; a spatial transform block which performs spatial transformation on the video frames to remove spatial redundancy from the video frames; a weight determination block which determines a weight to be used to scale transform coefficients obtained from some subbands among transform coefficients obtained as results of removing the temporal redundancy and the spatial redundancy from the video frames; a quantization block which quantizes scaled transform coefficients; and a bitstream generation block which generates a bitstream using the quantized transform coefficients.

The spatial transform block may perform wavelet transformation on the video frames to remove the spatial redundancy from the video frames, the temporal filtering block may generate transform coefficients using subbands obtained by performing the MCTF on the wavelet transformed video frames, and the weight determination block may determine the weight using the wavelet transformed frames and multiply the determined weight by transform coefficients that are obtained from some subbands, thereby obtaining the scaled transform coefficients.

The temporal filtering block may obtain subbands by performing the MCTF on the video frames, the weight determination block may determine the weight using the vide frames and multiply the determined weight by some of the subbands to obtain scaled subbands, and the spatial transform block may perform spatial transformation on the scaled subbands, thereby obtaining the scaled transform coefficients.

Also, the temporal filtering block may obtain subbands by performing the MCTF on the video frames, the spatial transform block may generate transform coefficients by performing spatial transformation on the subbands, and the weight determination block may determine the weight using the video frames and multiply the determined weight by transform coefficients obtained from predetermined subbands, thereby obtaining the scaled transform coefficients.

Here, the predetermined weight is preferably determined for each group of pictures (GOP) on the basis of a magnitude of absolute distortion of the GOP. Preferably, the transform coefficients scaled using the predetermined weight are obtained from subbands that exert substantially little influence on high Peak Signal to Noise Ratio (PSNR) frames than low PSNR frames among subbands used to construct low PSNR frames.

The bitstream generation block may include information regarding a weight used to obtain the scaled transform coefficients.

According to still another aspect of the present invention, there is provided a scalable video decoding method comprising extracting coded image information, coding order information, and weight information from a bitstream, obtaining scaled transform coefficients by dequantizing the coded image information, and performing descaling, inverse spatial transformation, and inverse temporal filtering on the scaled transform coefficients in a decoding order reverse to a coding order indicated by the coding order information, thereby recovering video frames.

The decoding order, for example, is descaling, inverse temporal filtering, and inverse spatial transformation. Otherwise, the decoding order may be inverse spatial transformation, descaling, and inverse temporal filtering or may be descaling, inverse spatial transformation, and inverse temporal filtering.

The predetermined weight, for example, is extracted from the bitstream for each group of pictures (GOP). Here, the number of frames constituting the GOP is 2^{k} (where k=1, 2, 3, . . . ).

For example, the transform coefficients to be inversely scaled using the predetermined weight are obtained from subbands W4, W6, W8, W10, W12, and W14 which have been generated during coding.

According to a further aspect of the present invention, there is provided a scalable video decoder comprising a bitstream analysis block which analyzes a received bitstream to extract coded image information, coding order information, and weight information from the bitstream, an inverse quantization block which dequantizes the coded image to obtain scaled transform coefficients, an inverse weighting block which performs descaling, an inverse spatial transform block which performs inverse spatial transformation, and an inverse temporal filtering block which performs inverse temporal filtering, the scalable video decoder performing descaling, inverse spatial transformation, and inverse temporal filtering on the scaled transform coefficients in an order reverse to a coding order indicated by the coding order information, thereby recovering video frames.

In a non-limiting example, the decoder performs decoding in the order of descaling, inverse temporal filtering, and inverse spatial transformation. Otherwise, the decoder may perform decoding in the order of inverse spatial transformation, descaling, and inverse temporal filtering or in the order of descaling, inverse spatial transformation, and inverse temporal filtering.

In a further, non-limiting example, the bitstream analysis block extracts the predetermined weight from the bitstream for each group of pictures (GOP). Here, the number of frames constituting the GOP is 2 k (where k=1, 2, 3, . . . ).

In accordance with one embodiment, the inverse weighting block performs inverse scaling with respect to the transform coefficients scaled from subbands W4, W6, W8, W10, W12, and W14 which have been generated during coding.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of conventional Interframe Wavelet Video Coding (IWVC);

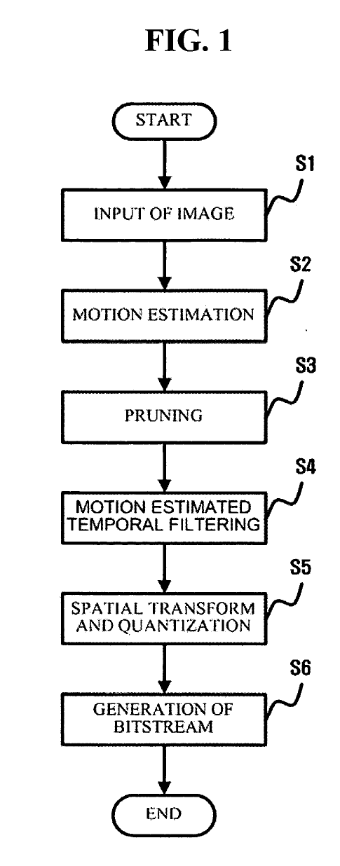

FIG. 2 illustrates conventional Motion Compensated Temporal Filtering (MCTF);

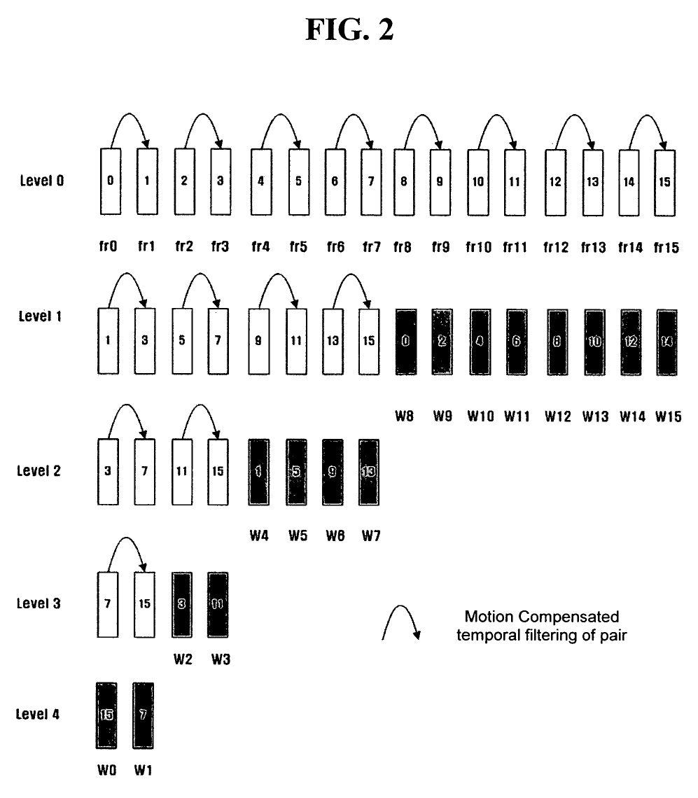

FIG. 3 is a graph showing Peak Signal to Noise Ratios (PSNRs) appearing when a Foreman sequence of two groups of pictures (GOPs) is subjected to conventional IWVC at a speed of 512 Kbps;

FIG. 4 is a flowchart of a scalable video coding method according to an embodiment of the present invention;

FIG. 5 illustrates a procedure for determining subbands to be scaled according to an embodiment of the present invention;

FIG. 6 illustrates a profile of an optimal scaling factor according to a Magnitude of Absolute Distortion (MAD);

FIG. 7 is a graph for comparing average PSNR values obtained in the present invention and those obtained in conventional technology;

FIG. 8 illustrates MCTF using different temporal directions according to an embodiment of the present invention;

FIG. 9 is a functional block diagram of a scalable video encoder according to an embodiment of the present invention;

FIG. 10 is a functional block diagram of a scalable video encoder according to another embodiment of the present invention; and

FIG. 11 is a functional block diagram of a scalable video decoder according to an embodiment of the present invention.

### DETAILED DESCRIPTION OF THE INVENTION

Exemplary, non-limiting, embodiments of the present invention will now be described in detail with reference to the accompanying drawings.

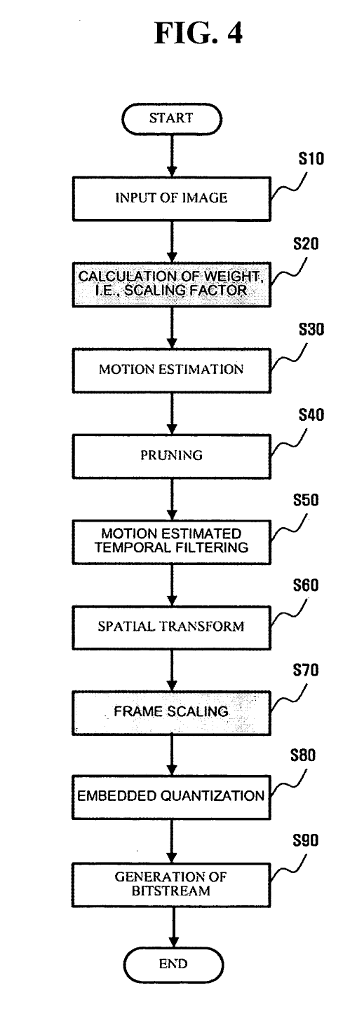

FIG. 4 is a flowchart of a scalable video coding method according to an embodiment of the present invention.

First, an image is received in units of a group of pictures (GOP) including a plurality of frames in step S10. In an embodiment of the present invention, a single GOP includes 16 frames, and all operations are performed in GOP units.

After receiving the image, a weight, i.e., a scaling factor is calculated in step S20. Calculation of the scaling factor will be described later.

Thereafter, motion estimation is performed using Hierarchical Variable Size Block Matching (HVSBM) in step S30. After the motion estimation, a motion estimation tree is pruned such that a Magnitude of Absolute Distortion (MAD) is minimized in step S40.

Next, Motion Compensated Temporal Filtering (MCTF) is performed using the pruned optimal motion estimation tree in step S50. As a result of the MCTF, a total of 16 subbands including 15 high-frequency subbands and a single low-frequency subband are obtained. The 16 subbands are subjected to spatial transformation in step S60. Discrete cosine transformation (DCT) may be used as the spatial transformation, but it is preferable to use wavelet transformation. Thereafter, in step S70, frame scaling is performed using the scaling factor obtained in step S20. The frame scaling will be described later. After the frame scaling, embedded quantization is performed in step S80, and then a bitstream is generated in step S90. The bitstream includes coded image information, motion vector information, and scaling factor information. During the coding, spatial transformation may be followed by temporal transformation, and scaling may be performed after the temporal transformation. Information regarding a coding order may be included in the bitstream so a decoder can identify different coding orders. However, the bitstream does not necessarily include coding order information. When coding order information is not included in the bitstream, coding may be recognized as being performed in a predetermined order. In embodiments of the present invention, a high-frequency subband indicates a result ((a−b)/2) of comparing two image frames (“a” and “b”), and a low-frequency subband indicates an average ((a+b)/2) of two image frames. However, the present invention is not restricted thereto. For example, a high-frequency subband may indicate a difference (a−b) between two frames, and a low-frequency subband may indicate one frame (a) of two compared frames.

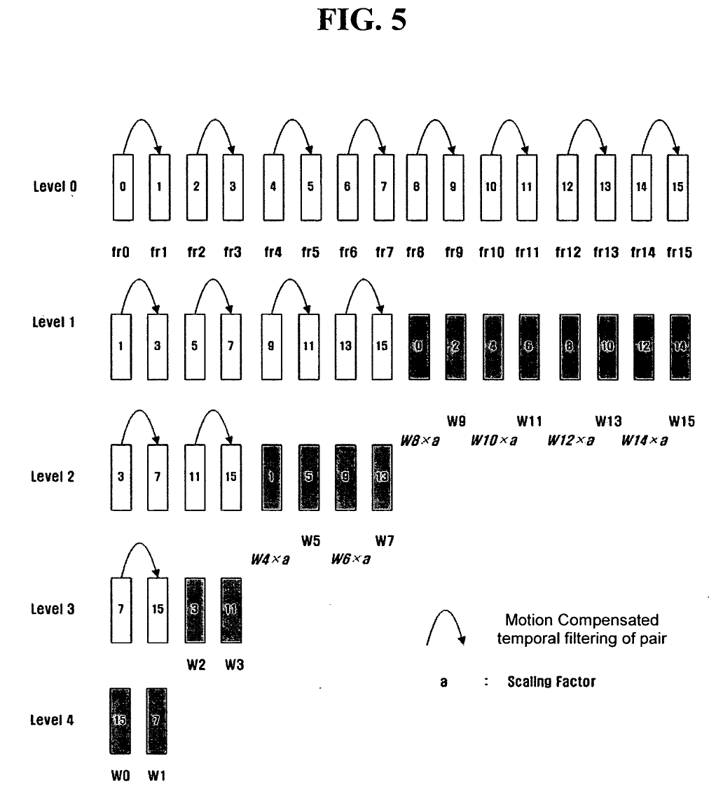

FIG. 5 illustrates a procedure for determining subbands to be scaled according to an embodiment of the present invention. Subbands indicate a plurality of high-frequency frames and a single low-frequency frame which are obtained as a result of temporal filtering. The high-frequency frames are referred to as high-frequency subbands, and the low-frequency frame is referred to as a low-frequency subband. In scalable video coding, MCTF is used as temporal filtering. When using MCTF, temporal redundancy can be removed, and temporal scalability can be obtained.

A relationship between video frames fr0 through fr15 and subbands W0 through W15 resulting from MCTF and a method of recovering temporal frames will be described with reference to FIG. 5. The relationship between the video frames fr0 through fr15 and the subbands W0 through W15 can be defined as follows:
fr15=W0+W1+W3+W7+W15
fr14=W0+W1+W3+W7−W15
fr13=W0+W1+W3−W7+W14
fr12=W0+W1+W3−W7−W14
fr11=W0+W1−W3+W6+W13
fr10=W0+W1−W3+W6−W13
fr9=W0+W1−W3−W6+W12
fr8=W0+W1−W3−W6−W12
fr7=W0−W1+W2+W5+W11
fr6=W0−W1+W2+W5−W11
fr5=W0−W1+W2−W5+W10
fr4=W0−W1+W2−W5−W10
fr3=W0−W1−W2+W4+W9
fr2=W0−W1−W2+W4−W9
fr1=W0−W1−W2−W4+W8
fr0=W0−W1−W2−W4−W8.

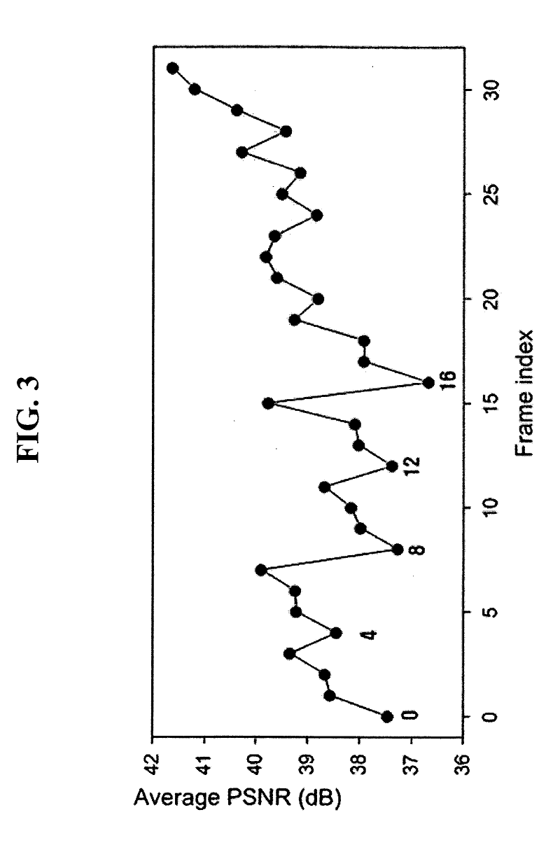

As shown in FIG. 3, the frames fr0, fr4, fr8, and fr12 have especially low Peak Signal to Noise Ratios (PSNRs) compared to neighboring frames, and they are referred to as low-PSNR frames. The reason that low-PSNR frames periodically appear is related to an MCTF order. In other words, motion estimation errors occur during MCTF and tend to be accumulated as a temporal level increases. A degree of accumulation is determined by an MCTF structure. The degree of accumulation is high with respect to frames replaced by high-frequency subbands at low temporal levels. Conversely, frames that are replaced by high-frequency subbands at high temporal levels and a frame that is replaced by a low-frequency subband at a highest temporal level have high PSNR values, and these frames are referred to as high-PSNR frames.

Accordingly, filtered subbands to be multiplied by a scaling factor may be selected from among the subbands needed to reconstruct the low-PSNR frames. Multiplication by a scaling factor indicates allocation of more bits. In other words, when considering that bits are preferentially allocated to bigger transform coefficients during the embedded quantization, multiplying subbands by a scaling factor indicates that more bits are allocated to transform coefficients obtained from the selected subbands than to other transform coefficients. Allocating more bits to low-PSNR frames in a GOP coded using a predetermined number of bits means that less bits are allocated to frames other than the low-PSNR frames in the GOP. As such, PSNR values of high-PSNR frames are decreased while PSNR values of low-PSNR frames are increased. Subbands that are needed to reconstruct low-PSNR frames and also exert less influence on high-PSNR frames are selected to be multiplied by a scaling factor. In other words, subbands (hereinafter, referred to as minimum change subbands) that are least used to reconstruct high-PSNR frames should be selected. Accordingly, the subbands W8, W10, W12, and W14 are primarily selected. However, since the frames fr0 and fr8 have especially lower PSNR values than other frames, special compensation is required for the frames fr0 and fr8. For this reason, in the embodiment of the present invention, the subbands W4 and W6 are additionally selected as minimum change subbands to be multiplied by a scaling factor so that a change in a PSNR value is greatly decreased.

As such, as shown in FIG. 5, among the subbands W0 through W15 obtained using MCTF, the minimum change subbands W4, W6, W8, W10, W12 and W14 are multiplied by a scaling factor “a”. In order to reduce the amount of calculation for video coding, it is preferable to calculate a scaling factor for each GOP, instead of calculating scaling factors with respect to all the frames together in a video one at a time. In the above described embodiment of the present invention, the same scaling factor is used for the minimum change subbands W4, W6, W8, W10, W12 and W14 in order to reduce the amount of calculation, but the sprit of the present invention is not restricted to the above-described embodiment. It should be construed that video coding and decoding technology in which subbands obtained through an MCTF operation are weighted in order to decrease a change in a PSNR value is included in the sprit of the present invention. Accordingly, a case where subbands are multiplied by different scaling factors is also included in the scope of the present invention.

A scaling factor to be multiplied by subbands can be determined using various methods. In an embodiment of the present invention, a scaling factor is obtained with respect to each GOP according to a MAD. In the embodiment of the present invention, the MAD is defined by Equation (1).

$$MAD = 8 \times {\sum }_{i = 0}^{\frac{n - 1}{2}} {\sum }_{x = 0}^{p - 1} {\sum }_{y = 0}^{q - 1} \vert {T}_{2 i + 1} ( x , y ) - {T}_{2 i} ( x , y ) \vert \qquad ( 1 )$$

Here, “i” indicates a frame index, “n” indicates a last frame index in a GOP, T(x, y) indicates a picture value at a position (x, y) in a T frame, and a size of a single frame is p*q.

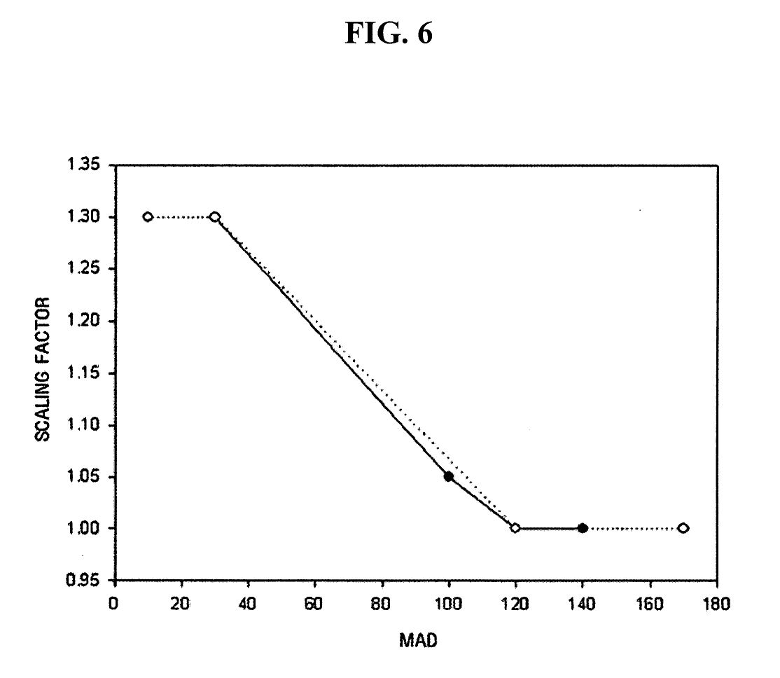

To implement the present invention, scaling factors were multiplied by subbands according to MADs. Next, a PSNR value of each frame was obtained. Next, optimal scaling factors “a” are obtained as shown in FIG. 6.

FIG. 6 illustrates a profile of an optimal scaling factor according to a MAD. In FIG. 6, the solid line is a graph of values obtained in the actual experiment, and the dotted line is a graph obtained by approximating the values with a linear equation. The scaling factor “a” is obtained using Equation (2).
a=1.3(if MAD<30) a=1.4−0.0033MAD (if 30<MAD<140) a=1(if MAD>140) (2)
After obtaining the scaling factor “a”, scaling is performed on subbands. In other words, among the subbands W0 through W15 obtained using MCTF, the minimum change subbands W4, W6, W8, W10, W12 and W14 are subjected to scaling according to Equation (3).
W4=a*W4, W6=a*W6 W8=a*W8, W10=a*W10 W12=a*W12, W14=a*W14(“a” is obtained using Equation (2) (3)

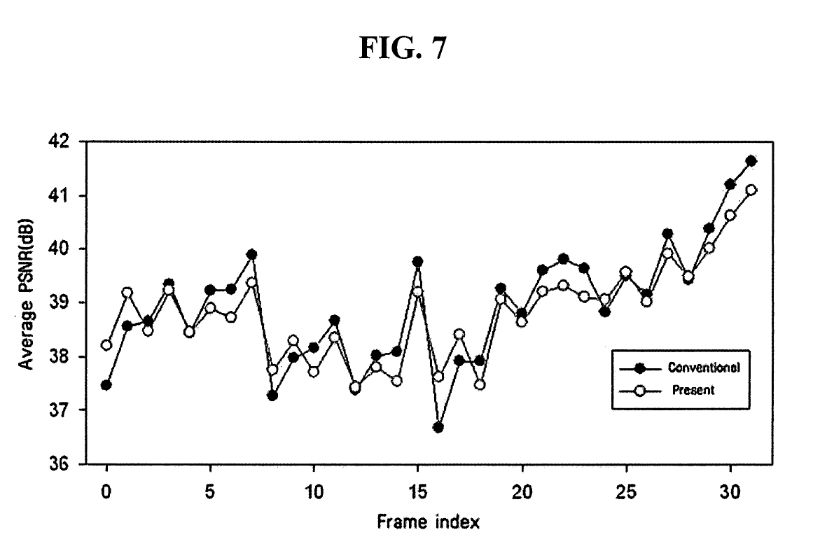

FIG. 7 is a graph for comparing average PSNR values obtained in an embodiment of the present invention and those obtained in a case using conventional MCTF.

Referring to FIG. 7, a change in a PSNR value is less in the embodiment of the present invention than in the case using the conventional MCTF. In addition, it can be seen that low PSNR values in the conventional case are increased in the present invention while high PSNR values in the conventional case are decreased in the present invention.

Besides a method of weighting some of the frames in a GOP during conventional MCTF performed only in a forward direction, PSNR values can be increased by combining forward temporal filtering and reverse temporal filtering according to a predetermined rule during MCTF. Examples of combined forward and reverse temporal filtering are shown in Table 1.

TABLE 1

| Mode flag | Level 0 | Level 1 | Level 2 | Level 3 |
|---|---|---|---|---|
| Forward (F = 0) | ++++++++ | ++++ | ++ | + |
| Reverse (F = 1) | −−−−−−−− | −−−− | −− | − |
| Combined forward | | | | |
| and reverse (F = 2) | | | | |
| Case (a) | +−+−+−+− | ++−− | +− | +(−) |
| Case (b) | +−+−+−+− | +−+− | +− | +(−) |
| Case (c) | ++++++++ | ++−− | +− | − |
| Case (d) | ++++−−−− | ++−− | +− | − |

Cases (c) and (d) are characterized in that a low-frequency frame (hereinafter, referred to as a reference frame) at a last level is positioned at a center (i.e., an 8th frame) among 1st through 16th frames. The reference frame is the most essential frame in video coding. The other frames are recovered based on the reference frame. As a temporal distance between a frame and the reference frame increases, recovery performance decreases. Accordingly, in cases (c) and (d), a combination of forward temporal filtering and reverse temporal filtering is made such that the reference frame is positioned at the center, i.e., the 8th frame, to minimize a temporal distance between the reference frame and each of the other frames.

In cases (a) and (b), an average temporal distance (ATD) is minimized. To calculate an ATD, temporal distances are calculated. A temporal distance is defined as a positional difference between two frames. Referring to FIG. 3, a temporal distance between a first frame and a second frame is defined as 1, and a temporal distance between a frame 2 and a frame 4 is defined as 2. An ATD is obtained by dividing the sum of temporal distances between frames subjected to an operation for motion estimation in pairs by the number of pairs of frames defined for the motion estimation. In case (a),

$$ATD = \frac{8 \times 1 + 4 \times 1 + 2 \times 4 + 1 \times 3}{15} = 1.53 .$$

In case (b),

$$ATD = \frac{8 \times 1 + 4 \times 1 + 2 \times 3 + 1 \times 5}{15} = 1.53 .$$

In the forward mode and the reverse mode shown in Table 1,

$$ATD = \frac{8 \times 1 + 4 \times 2 + 2 \times 4 + 1 \times 8}{15} = 2.13 .$$

In case (c),

$$ATD = \frac{8 \times 1 + 4 \times 2 + 2 \times 4 + 1 \times 2}{15} = 1.73 .$$

In case (d), ATD=8×1+4×1+2×4+1×1/15=1.67. In actual simulations, as an ATD was decreased, a PSNR value was increased so that performance of video coding was increased.

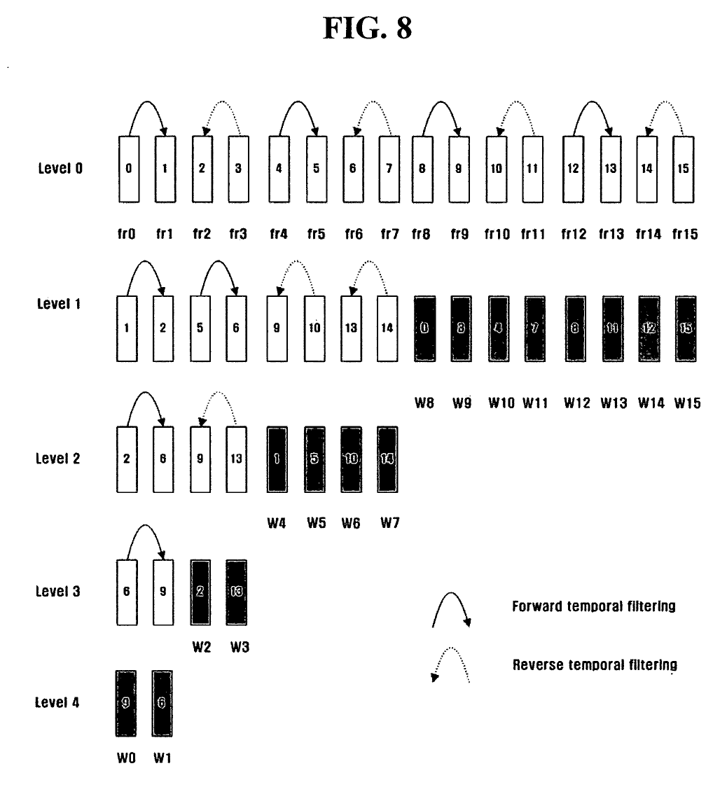

FIG. 8 illustrates MCTF performed in different temporal directions shown in case (a). The solid lines indicate forward temporal filtering, and the dotted lines indicate reverse temporal filtering. When the MCTF is performed as shown in FIG. 8, relationships between the frames fr0 through fr15 and the subbands W0 through W15 are defined as follows:
fr15=W0+W1−W3−W7−W15
fr14=W0+W1−W3−W7+W15
fr13=W0+W1−W3+W7+W14
fr12=W0+W1−W3+W7−W14
fr11=W0+W1+W3−W6−W13
fr10=W0+W1+W3−W6+W13
fr9=W0+W1+W3+W6+W12
fr8=W0+W1+W3+W6−W12
fr7=W0−W1+W2+W5−W11
fr6=W0−W1+W2+W5+W11
fr5=W0−W1+W2−W5+W10
fr4=W0−W1+W2−W5−W10
fr3=W0−W1−W2+W4−W9
fr2=W0−W1−W2+W4+W9
fr1=W0−W1−W2−W4+W8
fr0=W0−W1−W2−W4−W8.

In case (a) from Table 1, PSNR values also change according to frame indexes. Frame indexes having low PSNR values are determined, and minimum change subbands that exert less influence on frames than frames corresponding to the determined frame indexes are also determined. After calculating a MAD, the minimum change subbands are multiplied by an appropriate scaling factor. According to a direction of temporal filtering during the MCTF, a frame corresponding to a particular index in a GOP has good performance while a frame corresponding to another particular index in the GOP has poor performance. The present invention is characterized by operations of determining frame indexes having low PSNR values when a temporal filtering order is determined, then determining minimum change subbands that exert less influence on frames other than frames corresponding to the determined frame indexes among subbands used to reconstruct the frames corresponding to the determined frame indexes, and then multiplying the minimum change subbands by scaling factors. In an embodiment of the present invention, a single scaling factor is used for subbands in a GOP and is determined according to a MAD.

In addition, even when MCTF is performed using a plurality of reference frames unlike conventional MCTF, multiplication of a scaling factor can be performed using relationships between frames and subbands in the same manner as described above.

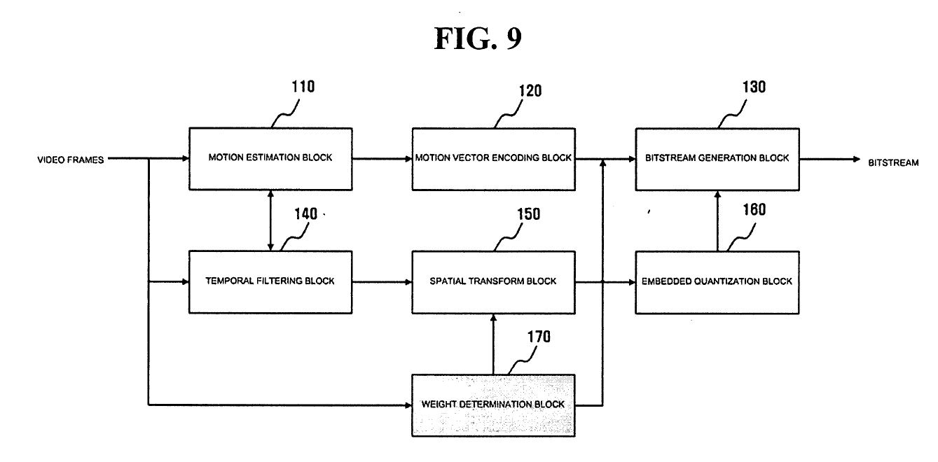

FIG. 9 is a functional block diagram of a scalable video encoder according to an embodiment of the present invention.

The scalable video encoder includes a motion estimation block 1 10, a motion vector encoding block 120, a bitstream generation block 130, a temporal filtering block 140, a spatial transform block 150, an embedded quantization block 160, and a weight determination block 170.

The motion estimation block 1 10 obtains a motion vector of a block in each frame to be coded based on a matching block in a reference frame. The frames are also used by the temporal filtering block 140. Motion vectors may be obtained using a hierarchical method such as Hierarchical Variable Size Block Matching (HVSBM). Motion vectors obtained by the motion estimation block 110 are provided to the temporal filtering block 140 so that MCTF can be performed. The motion vectors are also coded by the motion vector encoding block 120 and then included in a bitstream by the bitstream generation block 130.

The temporal filtering block 140 performs temporal filtering of video frames with reference to the motion vectors received from the motion estimation block 1 10. Temporal filtering is performed using MCTF and is not restricted to conventional MCTF. For example, a temporal filtering order may be changed, or a plurality of reference frames may be used.

Meanwhile, the weight determination block 170 calculates a MAD with respect to the video frames using Equation (1) and obtains a weight using the calculated MAD according to Equation (2). The obtained weight may be multiplied by subbands according to Equation (3).

In an exemplary embodiment, the weight is multiplied by transform coefficients resulting from spatial transformation performed by the spatial transform block 150. In other words, transform coefficients are obtained by spatially transforming the subbands to be multiplied by the weight in Equation (3), and then the transform coefficients are multiplied by the weight. It is apparent that multiplication of the weight may be performed after temporal filtering, and thereafter, spatial transformation may be performed.

Transform coefficients scaled according to the weight are transmitted to the embedded quantization block 160. The embedded quantization block 160 performs embedded quantization of the scaled transform coefficients, thereby generating coded image information. The coded image information and the coded motion vector are transmitted to the bitstream generation block 130. The bitstream generation block 130 generates a bitstream including the coded image information, the coded motion vector, and weight information. The bitstream is transmitted through a channel.

According to the exemplary embodiment, the spatial transform block 150 removes spatial redundancy with respect to the video frames using wavelet transformation to obtain spatial scalability. Alternatively, the spatial transform block 150 may use DCT to remove spatial redundancy with respect to the video frames.

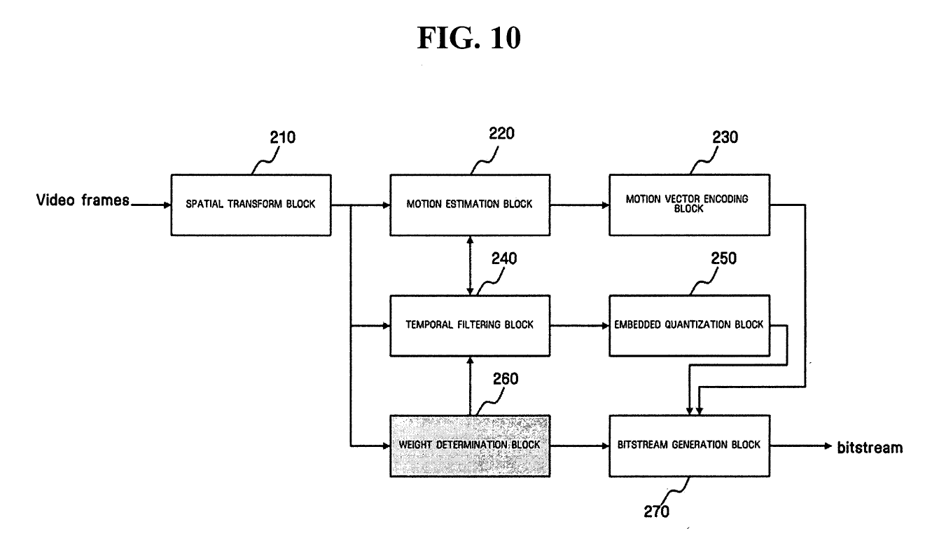

Meanwhile, when wavelet transformation is used, unlike conventional video coding, spatial transformation may be performed prior to temporal filtering. This operation will be described with reference to FIG. 10.

FIG. 10 is a functional block diagram of a scalable video encoder according to another embodiment of the present invention.

Referring to FIG. 10, video frames are wavelet-transformed by a spatial transform block 210. According to the well known method of wavelet transformation, a single frame is divided into four, a quadrant of the frame is replaced with a reduced image (referred to as an L image) which is similar to an entire image of the frame and has ¼ of the area of the frame, and the other three quadrants of the frame are replaced with information (referred to as an H image) based on which the entire image can be recovered from the L image. In the same manner, an L image frame can be replaced with an LL image having ¼ of the area of the L image frame and information based on which the L image can be recovered. Image compression using such a wavelet method is used by a compression method referred to as JPEG2000. Unlike a DCT image, a wavelet-transformed image includes original image information and enables video coding having spatial scalability using a reduced image.

A motion estimation block 220 obtains motion vectors with respect to spatially transformed frames. The motion vectors are used for temporal filtering by a temporal filtering block 240. The motion vectors are also coded by a motion vector encoding block 230 and then included in a bitstream generated by a bitstream generation block 270.

A weight determination block 260 determines a weight based on the spatially transformed frames. The determined weight is multiplied by transform coefficients obtained from minimum change subbands among subbands resulting from temporal filtering. Scaled transform coefficients are quantized by an embedded quantization block 250 and are thus converted into a coded image. The coded image is used together with the motion vectors and the weight by the bitstream generation block 270 to generate a bitstream.

Meanwhile, a video encoder may include both of the video encoders shown in FIGS. 9 and 10 to perform two types of video encoding and may generate a bitstream using a coded image obtained using a coding order giving better performance among the coding orders shown in FIGS. 9 and 10 with respect to each GOP. In this video encoder, information regarding a coding order is included in a bitstream to be transmitted. In the embodiments shown in FIGS. 9 and 10, information regarding a coding order may also be included in a bitstream so that a decoder can decode all of the images that have been coded in different orders.

When temporal filtering is performed prior to spatial transform in conventional video compression, a transform coefficient indicates a value generated through spatial transformation. In other words, a transform coefficient is referred to as a DCT coefficient when it is generated through DCT or is referred to as a wavelet coefficient when it is generated through wavelet transformation.

In embodiments of the present invention, the term “transform coefficient” is intended to mean a value obtained by removing spatial redundancy and temporal redundancy from frames before being subjected to quantization (i.e., embedded quantization). In other words, in the embodiment shown in FIG. 9, a transform coefficient indicates a coefficient generated through spatial transform like in conventional video compression. However, in the embodiment shown in FIG. 10, a transform coefficient indicates a coefficient generated through temporal filtering.

The term “scaled transform coefficients” used in the present invention is intended to encompass values generated by scaling transform coefficients using a weight or by performing spatial transformation on results of scaling subbands, which are obtained through temporal filtering, using a weight. Meanwhile, transform coefficients that are not scaled using a weight may be considered as being multiplied by 1, and therefore, scaled transform coefficients may include transform coefficients that have not been scaled as well as transform coefficients that have been scaled using a weight.

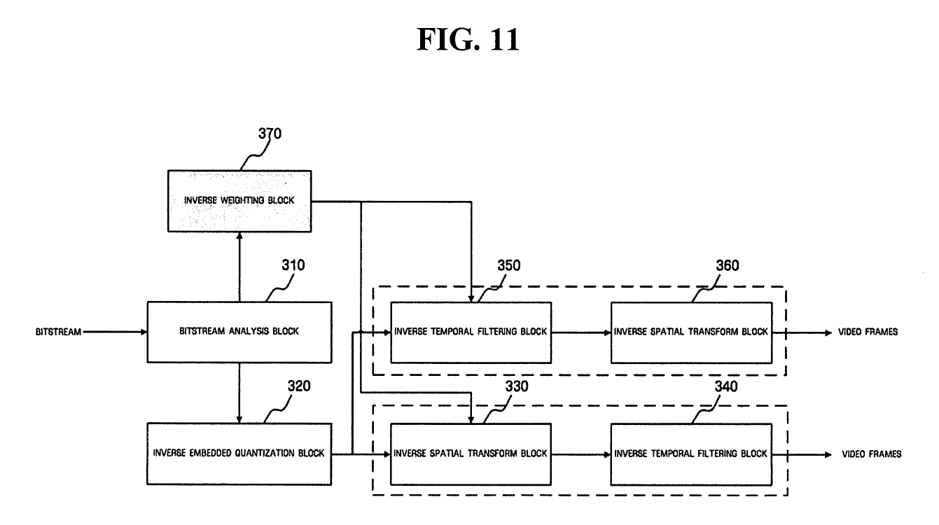

FIG. 11 is a functional block diagram of a scalable video decoder according to an embodiment of the present invention.

The scalable video decoder includes a bitstream analysis block 310 which analyzes an input bitstream, thereby extracting coded image information, coded motion vector information, and weight information; an inverse embedded quantization block 320 which dequantizes the coded image information extracted by the bitstream analysis block 310, thereby obtaining scaled transform coefficients; an inverse weighting block 370 which descales the scaled transform coefficients using the weight information; inverse spatial transform blocks 330 and 360 which perform inverse spatial transformation; and inverse temporal filtering blocks 340 and 350 which perform inverse temporal filtering.

The scalable video decoder shown in FIG. 11 includes the two inverse temporal filtering blocks 340 and 350 and the two inverse spatial transformation blocks 330 and 360 so that it can recover all images that have been coded in different orders. However, in an actual implementation, temporal filtering and spatial transformation can be performed on a computing apparatus using software. In this case, only a single software module for temporal filtering and only a single software module for spatial transformation may be provided together with the option of selecting an operating order.

The bitstream analysis block 310 extracts coded image information from a bitstream and transmits the coded image information to the inverse embedded quantization block 320. Then, the inverse embedded quantization block 320 performs inverse embedded quantization on the coded image information, thereby obtaining scaled transform coefficients. The bitstream analysis block 310 also transmits weight information to the inverse weighting block 370.

The inverse weighting block 370 descales the scaled transform coefficients based on the weight information to obtain transform coefficients. Descaling is related with a coding order. When coding has been performed in the order of temporal filtering, spatial transform, and scaling, the inverse weighting block 370 descales the scaled transform coefficients prior to the inverse spatial transform block 330. Next, the inverse spatial transform block 330 performs inverse spatial transformation. Thereafter, the inverse temporal filtering block 340 recovers video frames through inverse temporal filtering.

When coding has been performed in order of temporal filtering, scaling, and spatial transformation, the inverse spatial transform block 330 performs inverse spatial transformation on the scaled transform coefficients, and then the inverse weighting block 370 descales the scaled transform coefficients that have been processed by the inverse spatial transform block 330. Thereafter, the inverse temporal filtering block 340 recovers video frames through inverse temporal filtering.

When coding has been performed in order of spatial transformation, temporal filtering, and scaling, the inverse weighting block 370 descales the scaled transform coefficients, thereby obtaining transform coefficients. Next, the inverse temporal filtering block 350 constructs an image using the transform coefficients and performs inverse temporal filtering on the image. Next, the inverse spatial transform block 360 performs inverse spatial transformation on the image, thereby recovering video frames. The coding order may be changed by GOP. In this situation, the bitstream analysis block 310 obtains coding order information from a GOP header of a bitstream. Meanwhile, a basic coding order may be predetermined, and a bitstream may not include coding order information. In this situation, decoding can be performed in an order reverse to the basic coding order. For example, when the basic coding order is temporal filtering, spatial transformation, and scaling, if a bitstream does not include coding order information, descaling, inverse spatial transformation, and inverse temporal filtering are sequentially performed on the bitstream (i.e., decoding is performed using the inverse spatial transform block 330 and the inverse temporal filtering block 340 within a lower dotted box in FIG. 11).

In the above-described embodiments, it has been described that a scalable video encoder transmits a bitstream including weights, and a scalable video decoder recovers a video image using the weights. The present invention is not restricted thereto. For example, a scalable video encoder may transform information (i.e., MAD information), and a scalable video decoder may obtain weights from the information.

A video encoder and a video decoder may be implemented in hardware. Alternatively, they may be implemented using a universal computer, which includes a central processing unit capable of computing and memory, and software for performing encoding and decoding methods. Such software may be recorded in a recording medium such as a compact disc-read only memory (CD-ROM) or a hard disc so that the software can implement a video encoder and a video decoder together with a computer.

Therefore, it will be understood by those of ordinary skill in the art that various changes in form and details may be made therein without departing from the spirit and scope of the present invention as defined by the following claims. In the above-described embodiments, MCTF has been used, but any types of periodic temporal filtering will be construed as being included in the scope of the present invention.

Therefore, it is to be understood that the above described embodiment is for purposes of illustration only and not to be construed as a limitation of the invention. The scope of the invention is given by the appended claims, rather than the preceding description, and all variations and equivalents which fall within the range of the claims are intended to be embraced therein.

The present invention provides a model capable of reducing a change in a PSNR value between frame indexes in scalable video coding. In other words, according to the present invention, high PSNR values of frames in a single GOP are decreased while low PSNR values of other frames in the GOP are increased so that video coding performance can be improved. Values obtained through experiments of the present invention are shown in Tables 2 through 7. In the present invention, an average PSNR is not much different from that obtained through conventional MCTF. However, the present invention decreases a standard deviation compared to the conventional MCTF.

TABLE 2
Average PSNRs in Foreman Sequence

| Bit rate | Present invention | Conventional MCTF (Forward filtering) |
|---|---|---|
| 128 | 30.88 | 30.91 |
| 256 | 35.66 | 35.68 |
| 512 | 39.19 | 39.23 |
| 1024 | 43.65 | 43.71 |

TABLE 3
Standard Deviations in Foreman Sequence

| Bit rate | Present invention | Conventional MCTF (Forward filtering) |
|---|---|---|
| 128 | 1.22 | 1.23 |
| 256 | 0.89 | 0.94 |
| 512 | 0.75 | 0.84 |
| 1024 | 0.62 | 0.74 |

TABLE 4
Average PSNRs in Canoa Sequence

| Bit rate | Present invention | Conventional MCTF (Forward filtering) |
|---|---|---|
| 128 | 28.46 | 28.45 |
| 256 | 32.58 | 32.58 |
| 512 | 37.76 | 37.76 |
| 1024 | 45.36 | 45.43 |

TABLE 5
Standard Deviations in Canoa Sequence

| Bit rate | Present invention | Conventional MCTF (Forward filtering) |
|---|---|---|
| 128 | 0.859 | 0.861 |
| 256 | 1.004 | 1.007 |
| 512 | 1.000 | 1.020 |
| 1024 | 1.070 | 1.090 |

TABLE 6
Average PSNRs in Tempete Sequence

| Bit rate | Present invention | Conventional MCTF (Forward filtering) |
|---|---|---|
| 128 | 27.98 | 27.99 |
| 256 | 32.2 | 32.28 |
| 512 | 35.42 | 35.5 |
| 1024 | 37.78 | 37.82 |

TABLE 7
Standard Deviations in Tempete Sequence

| Bit rate | Present invention | Conventional MCTF (Forward filtering) |
|---|---|---|
| 128 | 0.348 | 0.350 |
| 256 | 0.591 | 0.670 |
| 512 | 0.555 | 0.682 |
| 1024 | 0.564 | 0.654 |

1. A scalable video coding method comprising:
(a) receiving a plurality of video frames and performing Motion Compensated Temporal Filtering (MCTF) on the plurality of video frames to remove temporal redundancy from the video frames; and
(b) obtaining scaled transform coefficients from the video frames from which the temporal redundancy is removed, quantizing the scaled transform coefficients, and generating a bitstream.

2. The scalable video coding method of claim 1, wherein the video frames received in step (a) have been subjected to wavelet transformation so that spatial redundancy has been removed from the video frames, and the scaled transform coefficients are obtained by applying a predetermined weight to some subbands among the video frames from which the temporal redundancy has been removed.

3. The scalable video coding method of claim 1, wherein the scaled transform coefficients are obtained in step (b) by applying a predetermined weight to some subbands among the video frames from which the temporal redundancy has been removed and then performing spatial transformation on the weighted subbands.

4. The scalable video coding method of claim 1, wherein the scaled transform coefficients are obtained in step (b) by performing spatial transformation on the video frames from which the temporal redundancy has been removed and then applying a predetermined weight to transform coefficients obtained from some subbands among transform coefficients generated through the spatial transformation.

5. The scalable video coding method of claim 4, wherein the predetermined weight is determined for each group of pictures (GOP) and has a single and the same value for a single GOP.

6. The scalable video coding method of claim 5, wherein the predetermined weight is determined on the basis of a magnitude of absolute distortion of the GOP.

7. The scalable video coding method of claim 6, wherein the transform coefficients scaled using the predetermined weight are obtained from subbands that exert substantially little influence on high Peak Signal to Noise Ratio (PSNR) frames as compared to low PSNR frames among subbands used to construct low PSNR frames.

8. The scalable video coding method of claim 7, wherein each GOP comprises 16 frames; the MCTF is performed in a single direction; a Magnitude of Absolute Distortion (MAD) is calculated by the equation,
$$MAD = 8 \times {\sum }_{i = 0}^{\frac{n - 1}{2}} {\sum }_{x = 0}^{p - 1} {\sum }_{y = 0}^{q - 1} \vert {T}_{2 i + 1} ( x , y ) - {T}_{2 i} ( x , y ) \vert$$
where “i” indicates a frame index, “n” indicates a last frame index in the GOP, T(x, y) indicates a picture value at a position (x, y) in a T frame, and a size of a single frame is p*q; the predetermined weight “a” is calculated based on the following, a=1.3 (if MAD<30), a=1.4−0.0033MAD (if 30<MAD<140), and a=1 (if MAD>140); and the transform coefficients scaled using the predetermined weight are obtained from subbands W4, W6, W8, W10, W12, and W14.

9. The scalable video coding method of claim 1, wherein the bitstream generated in step (b) comprises information regarding a weight used to obtain the scaled transform coefficients.

10. A scalable video encoder which receives a plurality of video frames and generates a bitstream, the scalable video encoder comprising:
a temporal filtering block which performs Motion Compensated Temporal Filtering (MCTF) on the video frames to remove temporal redundancy from the video frames;
a spatial transform block which performs spatial transformation on the video frames to remove spatial redundancy from the video frames;
a weight determination block which determines a weight to be used to scale transform coefficients obtained from some subbands among transform coefficients obtained as results of removing the temporal redundancy and the spatial redundancy from the video frames;
a quantization block which quantizes scaled transform coefficients; and
a bitstream generation block which generates a bitstream using the quantized transform coefficients.

11. The scalable video encoder of claim 10, wherein the spatial transform block performs wavelet transformation on the video frames to remove the spatial redundancy from the video frames, the temporal filtering block generates transform coefficients using subbands obtained by performing the MCTF on the wavelet transformed video frames, and the weight determination block determines the weight using the wavelet transformed frames and multiplies the determined weight by transform coefficients that are obtained from some subbands, thereby obtaining the scaled transform coefficients.

12. The scalable video encoder of claim 10, wherein the temporal filtering block obtains subbands by performing the MCTF on the video frames, the weight determination block determines the weight using the video frames and multiplies the determined weight by some of the subbands to obtain scaled subbands, and the spatial transform block performs spatial transformation on the scaled subbands, thereby obtaining the scaled transform coefficients.

13. The scalable video encoder of claim 10, wherein the temporal filtering block obtains subbands by performing the MCTF on the video frames, the spatial transform block generates transform coefficients by performing spatial transformation on the subbands, and the weight determination block determines the weight using the video frames and multiplies the determined weight by transform coefficients obtained from predetermined subbands, thereby obtaining the scaled transform coefficients.

14. The scalable video encoder claim 13, wherein the predetermined weight is determined for each group of pictures (GOP) and has a single and the same value for a single GOP.

15. The scalable video encoder of claim 14, wherein the predetermined weight is determined on the basis of a magnitude of absolute distortion of the GOP.

16. The scalable video encoder of claim 15, wherein the transform coefficients scaled using the predetermined weight are obtained from subbands that exert substantially little influence on high Peak Signal to Noise Ratio (PSNR) frames as compared to low PSNR frames among subbands used to construct low PSNR frames.

17. The scalable video encoder of claim 16, wherein each GOP comprises 16 frames; the MCTF is performed in a single direction; a Magnitude of Absolute Distortion (MAD) is calculated by the equation
$$MAD = 8 \times {\sum }_{i = 0}^{\frac{n - 1}{2}} {\sum }_{x = 0}^{p - 1} {\sum }_{y = 0}^{q - 1} \vert {T}_{2 i + 1} ( x , y ) - {T}_{2 i} ( x , y ) \vert$$
where “i” indicates a frame index, “n” indicates a last frame index in the GOP, T(x, y) indicates a picture value at a position (x, y) in a T frame, and a size of a single frame is p*q; the predetermined weight “a” is calculated based on a=1.3 (if MAD <30), a=1.4−0.0033MAD (if 30<MAD<140), and a=1 (if MAD>140); and the transform coefficients scaled using the predetermined weight are obtained from subbands W4, W6, W8, W10, W12, and W14.

18. The scalable video encoder of claim 10, wherein the bitstream generation block includes information regarding a weight used to obtain the scaled transform coefficients.

19. A scalable video decoding method comprising:
extracting coded image information, coding order information, and weight information from a bitstream;
obtaining scaled transform coefficients by dequantizing the coded image information; and
performing descaling, inverse spatial transformation, and inverse temporal filtering on the scaled transform coefficients in a decoding order reverse to a coding order indicated by the coding order information, thereby recovering video frames.

20. The scalable video decoding method of claim 19, wherein the decoding order is descaling, inverse temporal filtering, and inverse spatial transformation.

21. The scalable video decoding method of claim 19, wherein the decoding order is inverse spatial transformation, descaling, and inverse temporal filtering.

22. The scalable video decoding method of claim 19, wherein the decoding order is descaling, inverse spatial transformation, and inverse temporal filtering.

23. The scalable video decoding method of claim 22, wherein the predetermined weight is extracted from the bitstream for each group of pictures (GOP).

24. The scalable video decoding method of claim 23, wherein the number of frames constituting the GOP is 2^{k} (where k=1, 2, 3, . . . ).

25. The scalable video decoding method of claim 23, wherein the transform coefficients to be inversely scaled using the predetermined weight are obtained from subbands W4, W6, W8, W10, W12, and W14 which have been generated during coding.

26. A scalable video decoder comprising:
a bitstream analysis block which analyzes a received bitstream to extract coded image information, coding order information, and weight information from the bitstream;
an inverse quantization block which dequantizes the coded image to obtain scaled transform coefficients;
an inverse weighting block which performs descaling;
an inverse spatial transform block which performs inverse spatial transformation; and
an inverse temporal filtering block which performs inverse temporal filtering,
the scalable video decoder performing descaling, inverse spatial transformation, and inverse temporal filtering on the scaled transform coefficients in an order reverse to a coding order indicated by the coding order information, thereby recovering video frames.

27. The scalable video decoder of claim 26, wherein the decoding order is descaling, inverse temporal filtering, and inverse spatial transformation.

28. The scalable video decoder of claim 26, wherein the decoding order is inverse spatial transformation, descaling, and inverse temporal filtering.

29. The scalable video decoder of claim 26, wherein the decoding order is descaling, inverse spatial transformation, and inverse temporal filtering.

30. The scalable video decoder of claim 29, wherein the bitstream analysis block extracts the predetermined weight from the bitstream for each group of pictures (GOP).

31. The scalable video decoder of claim 30, wherein the number of frames constituting the GOP is 2k (where k=1, 2, 3, . . . ).

32. The scalable video decoder of claim 26, wherein the inverse weighting block performs inverse scaling with respect to the transform coefficients scaled from subbands W4, W6, W8, W10, W12, and W14 which have been generated during coding.

33. A recording medium having computer-readable codes for executing the steps of the methods claimed in claims any one of claims 1 through 9 and 19 through 25.
